(19) United States
(12) Patent Application Publication
(10) Pub. No.: US 2026/0284861 A1
(43) Pub. Date: Sep. 24, 2026

(54) SYSTEM AND METHODS FOR MULTI-PURPOSE INTERCHANGEABLE ROBOTIC MODULES

(71) Applicant: Oqab Dietrich Induction Inc., Kitchener (CA)

(72) Inventors: Haroon B. Oqab, Kitchener (CA); George B. Dietrich, Kitchener (CA); Mateusz Kordasiewicz, Kitchener (CA); Cassandra Tom, Kitchener (CA); Vihangi Mehta, Kitchener (CA); Dylan Burke, Kitchener (CA); Eniife Elebute, Kitchener (CA); Joseph Thaliath, Kitchener (CA)

(21) Appl. No.: 19/475,134

(22) PCT Filed: Apr. 15, 2025
(86) PCT No.: PCT/CA2024/050485

§ 371 Date: Oct. 14, 2025

Related U.S. Application Data
(60) Provisional application No. 63/496,255, filed on Apr. 14, 2023.

(51) Int. Cl. B25J 5/00; A61G 5/10; B25J 9/08; B25J 9/10; B25J 13/02; B25J 15/00; B25J 19/00; G06F 3/01

(52) U.S. Cl. CPC B25J 5/007; A61G 5/10; B25J 9/08; B25J 9/102; B25J 13/025; B25J 19/0029; B25J 19/0045; B25J 15/00; B25J 19/007; G06F 3/016

(57) ABSTRACT

Provided are systems, devices, and methods for additively manufacturable robotic systems and platforms. A robotic system includes interchangeable modules such as a base, a linkage, a joint, and an end effector. The base, the linkage, the joint, and the end effector comprise a standard electrical and mechanical interface, such that the base, the linkage, the joint, and the end effector are configured to couple to one another. The interchangeable modules leverage artificial intelligence and machine learning techniques to optimize design, logistics, operations, maintenance and additively manufacturing of robotic systems.

### TECHNICAL FIELD

The embodiments disclosed herein relate to additively manufactured robotic platforms including interchangeable modules, and in particularly, modular, additively manufactured robotic limbs for applications for humanoids and/or assistive devices.

### INTRODUCTION

Robotics systems may be advantageously used in place of human labor to reduce labor costs, enable functionality that human labor may not provide, or augment human ability. For example, robotic systems may operate in extreme environments, such as outer space, which requires advanced equipment for humans to operate in.

Current robotic systems may comprise multiple interchangeable parts and modules. For example, a robotic arm may comprise an interchangeable end effector, which may be swapped depending on the use case. Such interchangeable components must be pre-designed and manufactured for the specific robotics platform and use case.

It may be desirable to quickly reconfigure robotic systems and components. Current reconfigurable robotic systems may require complicated design, tooling and manufacturing processes to produce novel robotic components.

Similarly, materials and subcomponents of robotic systems may be scarce and of limited availability. For example, precious metals such as gold may be required for electrical components. Metallic alloys such as aluminum, titanium, copper, nickel, magnesium and/or other composite alloys or the like may be used to construct mechanical components of robotic systems. Such materials may be energy intensive to manufacture and recycle. In some environments, such as outer space, material resources may be even more scarce or difficult to acquire.

Accordingly, there is a need for new robotics systems and platforms that overcome some of the disadvantages of existing solutions.

### SUMMARY

Described herein are robotic systems and associated methods. According to an embodiment, disclosed herein is a robotic system, the system comprising a base a linkage, a tee joint and an end effector, wherein the base, the linkage, the tee joint, and the end effector comprise a standard mechanical interface, such that the base, the linkage, the tee joint, and the end effector are configured to mechanically couple to one another, and wherein the base, linkage, tee joint and end effector are additively manufactured.

According to an embodiment, the base, the linkage, the tee joint, and the end effector comprise a standard electrical interface, wherein that the base, the linkage, the tee joint, and the end effector are configured to be electrically coupled to one another, such that electrical power and data is passed between the base, the linkage, the tee joint, and the end effector when assembled.

According to an embodiment, robotic system comprises an assistive device.

According to an embodiment, the robotic system is coupled to a wheelchair.

According to an embodiment, the base, the linkage, the tee joint, and the end effector are substantially constructed from PLA polymer.

According to an embodiment, the tee joint comprises two rotational degrees of freedom.

According to an embodiment, the tee joint comprises a planetary gear drive system.

According to an embodiment, the tee joint comprises at least one electric motor.

According to an embodiment, the robotic system is at least partially controlled by a human input device.

According to an embodiment, the human input device is configured to provide haptic feedback to an end user.

According to an embodiment, haptic feedback corresponds to the output of a force sensor integrated into the end effector.

According to an embodiment, the end effector comprises a mechanical gripper.

According to an embodiment, the robotic system is autonomously operated.

According to an embodiment, the robotic system applies artificial methods during autonomous operation.

According to an embodiment, the robotic system communicates with a second robotic system over a communication network.

According to an embodiment, the robotic system further comprises a control interface.

According to an embodiment, the robotic system is controlled by an end user operating a remote terminal.

According to an embodiment, the remote terminal includes an extended reality system, which may include mixed reality, virtual reality, and/or augmented reality operations.

According to an embodiment, the robotic system is configured to receive wireless power.

According to an embodiment, described herein is a method of manufacturing a robotic system, the method including providing a material source and 3D printer, producing an output component using 3D printer and a material from the material source, providing a first robotic system and assembling the output component into a second robotic system using the first robotic system.

According to an embodiment, the output component comprises multiple output components.

According to an embodiment, the second robotic system comprises an assistive device.

According to an embodiment, the second robotic system is coupled to a wheelchair.

According to an embodiment, the first robotic system and second robotic system are substantially constructed from PLA polymer.

According to an embodiment, the second robotic system is at least partially controlled by a human input device.

According to an embodiment, the human input device is configured to provide haptic feedback to an end user.

According to an embodiment, haptic feedback corresponds to the output of a force sensor integrated into an end effector.

According to an embodiment, the first robotic system is autonomously operated.

According to an embodiment, the first robotic system applies artificial intelligence and/or machine learning methods during autonomous operation.

According to an embodiment, the first robotic system communicates with another robotic system over a communication network.

According to an embodiment, the second robotic system is configured to be controlled by an end user operating a remote terminal.

According to an embodiment, the remote terminal includes a extended reality system, which may include mixed reality, virtual reality, and/or augmented reality operations.

According to an embodiment, the first robotic system is configured to receive wireless power.

According to an embodiment, disclosed herein is a method of operating a robotic system, the method including providing a robotic system comprising a robotic arm and a first end effector coupled to the robotic arm, operating the robotic system to perform an operation with the first end effector, removing the first end effector and coupling a second end effector to the robotic arm, wherein the second end effector provides for different functionality than the first end effector and operating the robotic system to perform an operation with the second end effector.

According to an embodiment, the robotic system is configured such that it may be additively manufactured.

According to an embodiment, the robotic system comprises an assistive device.

According to an embodiment, the robotic system is configured to be coupled to a wheelchair.

According to an embodiment, the robotic system is substantially constructed from PLA polymer.

According to an embodiment, the robotic system is at least partially controlled by a human input device.

According to an embodiment, the human input device is configured to provide haptic feedback to an end user using tactile and/or kinesthetic methods.

According to an embodiment, haptic feedback corresponds to the output of a force sensor integrated into the first end effector.

According to an embodiment, the robotic system is autonomously operated.

According to an embodiment, the robotic system applies artificial intelligence and/or machine learning methods during autonomous operation.

According to an embodiment, the robotic system communicates with another a plurality of robotic systems over a communication network.

According to an embodiment, the robotic system is configured to be controlled by one or more users operating a remote terminal.

According to an embodiment, the remote terminal includes extended reality system, which may include mixed reality, virtual reality, and/or augmented reality operations.

According to an embodiment, digital twins of operations may be utilized in the extended reality system to support training of operators, and/or support training of robotic systems utilizing artificial intelligence and machine learning techniques.

According to an embodiment, digital twins of operations may be utilized in the extended reality system to support maintenance schedules and or replacement of robotic systems where a first robotic systems is physically replaced by a second robotic system, and digital twin operations are then transferred from the first robotic system to a second robotic system.

According to an embodiment, the robotic system is configured to receive wireless power.

### BRIEF DESCRIPTION OF THE DRAWINGS

The drawings included herewith are for illustrating various examples of articles, methods, and apparatuses of the present specification. In the drawings:

FIG. 1 is a block diagram detailing a system for additively manufacturing robotic systems, according to an embodiment;

FIG. 2 is a block diagram detailing a system for additively manufacturing robotic systems, according to an embodiment;

FIG. 3 is a block diagram detailing constituent components of an additively manufactured robotic system;

FIG. 4 is a block diagram detailing a robotic system constructed from components of the robotic platform of FIG. 3, according to an embodiment;

FIG. 5A shows a perspective view of a robotic arm, based on an additively manufacturable robotics platform, according to an embodiment;

FIG. 5B shows a perspective view of a robotic arm, based on an additively manufacturable robotics platform, according to an embodiment;

FIG. 6 shows a perspective view of a male component of a mechanical interface, according to an embodiment;

FIG. 7A shows a detail perspective view of a linkage of the robotic arm of FIGS. 5A-B, according to an embodiment;

FIG. 7B shows a detail perspective view of a tee body of the robotic arm of FIGS. 5A-B, according to an embodiment;

FIG. 7C shows a detail perspective view of a base of the robotic arm of FIGS. 5A-B, according to an embodiment;

FIG. 8A shows a detail perspective view of a mechanical interface during a mating process, according to an embodiment;

FIG. 8B shows a cross sectional view along A-A of a mechanical interface during a mating process, according to an embodiment;

FIG. 8C shows a detail perspective view of a mechanical interface during a mating process, according to an embodiment;

FIG. 8D shows a cross sectional view along B-B of a mechanical interface during a mating process, according to an embodiment;

FIG. 8E shows a cross sectional view along A-A of a mated mechanical interface, according to an embodiment;

FIG. 9A shows a perspective view of the end effector of the robotic arm of FIGS. 5A-B, according to an embodiment;

FIG. 9B shows a perspective view of the end effector of the robotic arm of FIGS. 5A-B, according to an embodiment;

FIG. 10A shows a perspective view of the end effector of the robotic arm of FIGS. 5A-B, in a closed position, according to an embodiment;

FIG. 10B shows an elevation view of the end effector of the robotic arm of FIGS. 5A-B, in an open position, according to an embodiment;

FIG. 11 shows an elevation view of the worm drive system of the end effector of the robotic arm of FIGS. 5A-B, according to an embodiment;

FIG. 12 shows a perspective view of a tee junction of the robotic arm of FIGS. 5A-B, according to an embodiment;

FIG. 13 shows a partially exploded and transparent perspective view of a rotational junction of the robotic arm of FIGS. 5A-B, according to an embodiment;

FIG. 14A shows a front view of a portion of the rotational junction of FIG. 13, according to an embodiment;

FIG. 14B shows a rear perspective view of a portion of the rotational junction of FIG. 13, according to an embodiment;

FIG. 14C shows a front perspective view of a portion of the rotational junction of FIG. 13, with planet and sun gears removed, according to an embodiment;

FIG. 15 shows a perspective view of a robotic arm based on an additively manufacturable robotics platform applied as an assistive device, according to an embodiment;

FIG. 16A shows a perspective view of the robotic arm of FIG. 15, according to an embodiment;

FIG. 16B shows a perspective view of the robotic arm of FIG. 15, according to an embodiment;

FIG. 17 shows an electrical schematic of the robotic system of FIG. 15, according to an embodiment;

FIG. 18 shows a software architecture schematic of the control system of the robotic system of FIG. 15, according to an embodiment;

FIG. 19 shows a flow chart describing a method of manufacturing a robotic system, according to an embodiment;

FIG. 20 shows a flow chart describing a method of operating a robotic system, according to an embodiment;

FIG. 21 shows a table or objective and current specifications of the robotic system of FIG. 15, according to an embodiment; and

FIG. 22 shows an exploded view of an example cycloid gearbox, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

The present systems, devices, and methods for additively manufactured robotics platforms. Such platforms may include a plurality of inter-operable robotic components, wherein each component may be fully or largely additively manufactured. To enable inter-operability, components may be designed to utilize uniform mechanical and electrical transfer interfaces.

Robotic system as described herein may comprise any system which may be guided or programmed to carry out a complex series of action. A robotic system may comprise a robotic limb, such as one or more robotic arms and/or legs, which may be controlled manually by a human operator through a control terminal, or controlled autonomously through the application of input data from sensor systems and outputs determined by a control system. In some examples, the control system may apply artificial intelligence techniques to determine control outputs. In some examples, robotic systems may apply to humanoid robots, designed to resemble the human body in form or function. In other example examples robotic systems may be non-anthropomorphic or non-humanoid robots, for example industrial robots, wheeled robots, legged robots, aerial robots, aquatic robotics or bio-inspired or biomimetic robots.

Robotic platforms, as described herein, refer to systems enabling components of a robotic system to be swapped with other like or different components. A robotic platform may comprise specifications and standards, enabling standard mechanical and electrical interfaces, such that the robotic components may be readily interchanged, enabling continuous system improvement as improved components are designed and manufactured and implemented into the system. Similarly, a standardized platform enables greater functionality, as the platform may provide for differing functions based on differing interchangeable components. Finally, a standardized platform may promote system longevity and reliability, as only damaged or broken individual components must be replaced, which may reduce servicing and repair costs.

Additive manufacturing, as described herein, refers to a variety of processes in which material is deposited, joined or solidified, generally under computer control, to create a three-dimensional object, with material being added together (such as plastics, liquids or powder grains being fused together), typically layer by layer.

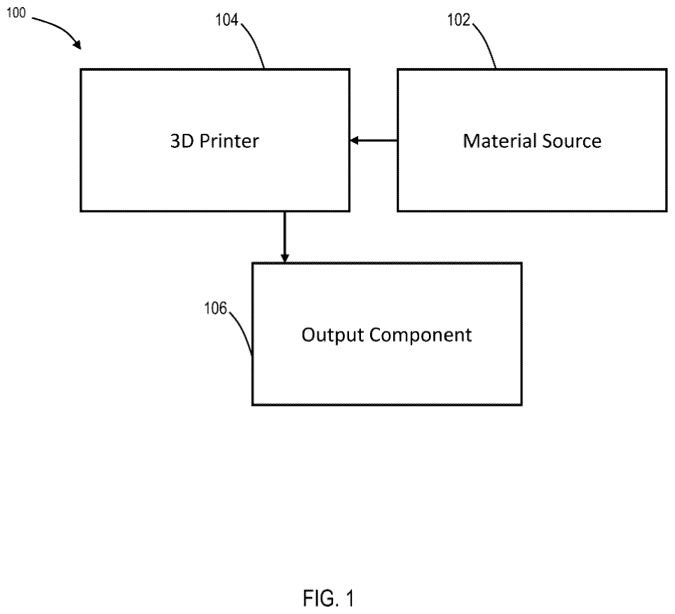

Modular, as used herein, means a subdivided system, which may be broken down into smaller parts called modules, which can be independently created, modified, replaced, or exchanged with other modules or between different systems Referring first to FIG. 1, shown therein is a block diagram detailing a system 100 for additively manufacturing robotic systems. System 100 comprises a 3D printer 104, material source 102 and output component 106. The term “3D printing” and variants thereof may be used interchangeably with the term “additive manufacturing” and variants thereof.

3D printer 104 may be any 3D printer known in the art that may contribute to the manufacture of robotic components. 3D printer may be broadly interpreted to include any device which may be provided with source materials and output component specifications as an input, and may output an output component, using additive manufacturing methods. 3D printer 104 may include stereolithography (SLA), Digital Light Processing(DLP), Selective Laser Sintering (SLS), Fused Deposition Modeling (FDM), Selective Laser Melting (SLM), Laminated Object Manufacturing (LOM), Continuous Liquid Interface Production (CLIP), Binder and or Material Jetting, Sheet Lamination, Direct Energy Deposition (DED), Direct Ink Writing (DIW) or Electron Beam Melting (EBM) type 3D printers. In some examples, 3D printer 104 may apply a combination of additive and subtractive manufacturing techniques. In some examples, 3D printer 104 may be configured to produce biological materials. In some examples, 3D printer 104 may be configured to produce inflatable and/or deployable structures.

Output component 106 may be any component outputted by the 3D printer 104, which may subsequently be assembled into a robotic system. Output component 106 may comprise core components, such as mechanical structures or linkages, tee joints, bases, mechanical fasters, mechanical interface components, joints, hinges and other mechanical components. Output component 106 may comprise electrical components such as, without limitation, wires, sensors, integrated circuits, diodes, resistors, capacitors, or inductors.

Material source 102 may comprise any source of materials, wherein the materials may be applied to additive manufacturing. For example, components may be manufactured from thermoplastic materials, other polymer materials, metallic materials or other common additive manufacturing materials. For example, materials of material source 102 may include ABS polymer.

In some examples, the robotic platform which may be contributed to by the output component 106 may be deployed in space applications. In these examples wherein the robotic platform is deployed in space, the robotic components of the platform may be manufactured from materials originating from Earth. For example, processed aluminum alloys may be transported from Earth to the space location of the robotic platform. These aluminum alloys may be used to additively manufacture additional robotic components.

In other space applications, the robotic components of the platform may be manufactured from materials originating from space resources. Space resources may include materials that may be sourced from sources other than Earth and its atmosphere. Space resources may be sourced from celestial bodies such as the Moon, Mars, other planets, asteroids or other space sources. For example, lunar regolith may be used to manufacture the components of the robotic platform described herein. In some examples, lunar regolith may be processed to extract subcomponents of the lunar regolith, such that these subcomponents may be used to manufacture robotic components. In some examples, materials are recycled in space using satellites, satellite components, defunct satellites, spent rocket bodies, space debris and or other non-functional space objects from Earth's orbit.

In some examples, materials are transported from Earth to Space to additive manufacture robotic systems. In other examples a combination of materials sourced from Earth and from Space are sourced as part of the additive manufacturing process.

In some examples, the additive manufacturing processes are adapted to autonomously match the micro-gravity environment, for example 3D printing on Earth versus in Space. The 3D printer may dynamically adjust printing parameters including but not limited to flow rates, nozzle temperatures, material handling, extrusion, heating, cooling, vibration, electromagnetic field strength and configuration, control, and layer heights to optimize print quality and reliability in different microgravity environments. In other examples, artificial intelligence and machine learning techniques are utilized to enable optimal operations in different microgravity environments.

In some examples, material source 102 may comprise biological materials. In such examples, 3D printer 104 may be utilized to grow biological or synthetic organisms into structures to generate output components 106. In other examples byproducts from extremophiles may be used to support the additive manufacturing process.

In some examples, material source 102 may further include a recycled material source. For example, retired robotic components may be provided back to material source 102 for recycling back into source material, such that the recycled materials may be provided back to 3D printer 104 for further manufacturing and use. In some examples, waste products or materials may be processed using biological, bio-organic or synthetic systems. Materials may be recycled using in situ utilization methods or processes.

Such a recycling process may be advantageous, as newly manufactured components may provide for greater functionality than older components. Therefore, older components may be recycled into newly manufactured components through system 100.

In some examples, materials, or a combination of materials, sourced from one or more celestial bodies, may be used to additively manufacture robotic components.

The modular structure of the platform described herein allows for the robotic system to remain adaptable, such that the system may be applied to various use cases, as system needs change over time. A material source 102 may be provided, such that feedstock material may be provided from the material source 102 to a 3D printer 104, such that components may be manufactured. 3D printer 104 may manufacture any component as required, producing an output component 106.

Using the system 100 as outlined at FIG. 1, the design of a robotic platform may evolve over time. For example, during a first year of operation, a robotic platform may provide for 3 discreet functions. In the fifth year of operation, the robotic platform may have evolved, through the design and production of additional additively manufactured components, the robotic platform may provide for 5 discreet functions. Additional functionality may be enabled through additional manufactured robotic components (e.g. output component 106). For example, the original robotic system at year one may only perform 3 functions, using an end effector which has been designed for the system. At the fifth year, a new end effector may be designed and produced, as output component 106, such that new functionality of the robotic system may be provided for.

Additionally, systems based on additive manufacturing methods may have reduced costs versus systems based on other manufacturing methods, as overhead costs may be lower, especially for smaller volume production runs.

In some examples, generative design processes and algorithms may be used to generate designs of output components 106 for provision to 3D printer 104.

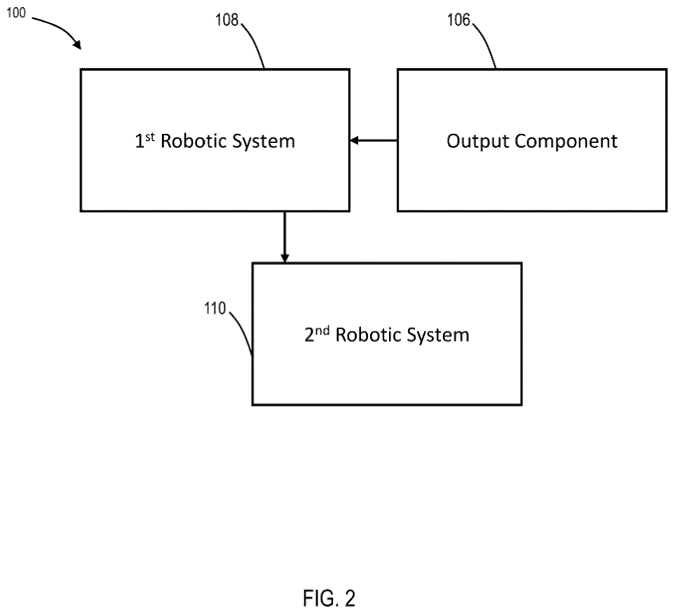

Referring now to FIG. 2, shown therein is a block diagram of a system 100 for additively manufacturing robotic systems. System 100 in FIG. 2 is pictured in the process of assembling additional robotic systems, based on the robotic platform. System 100 of FIG. 2 further includes 1^{st} robotic system 108, second robotic system 110 and output component 106.

First robotic system 108 comprises a robotic system which may be tasked with assembling the robotic components of another robotic system. For example, first robotic system 108 may include a dexterous robotic arm, which may pick up, manipulate and accurately place output components, such that they may be assembled into another robotic system. For example, the second robotic system may be a recycling system coupled with a 3D printer to produce useful products.

In some examples, first robotic system 108 may operate in several modes. For example, first robotic system 108 may include a robotic arm and several interchangeable end effectors, for example, a grappling end effector and a rotational / screwdriver end effector. The first robotic system 108 may switch between different modes of operation as needed. For example, first robotic system 108 may first place two output components 106 in the correct relative position, and partially place a screw (but not thread the screw) into a threaded hole to join the two components, all with the first grappling end effector. Subsequently, the first robotic system 108 may swap to the second, screwdriver end effector to drive and secure the screw to both components. Afterwards, the first robotic system 108 may continue to switch modes of operation as needed.

First robotic system 108 may include a number of sensor systems, for example, force/torque sensors, visual cameras, GPS, Inertial Measure Units (IMU), RADAR, SONAR, LIDAR, infrared sensors, ultrasonic sensors, tactile sensors, gravity gradiometer, proximity sensors and other sensors to detect the world around first robotic system 108, and provide input to the first robotic system 108.

First robotic system 108 may be autonomously operated. For example, the system 100 may be preconfigured to manufacture a certain known second robotic system 106. Accordingly, first robotic system 108 may be configured to autonomously assemble output components 106, such that second robotic system 106 may be assembled without outside human input.

In some examples, such configurations may apply artificial intelligence and machine learning techniques to enable autonomous operation. In some examples, supervised learning, unsupervised learning, semi-supervised learning, reinforcement learning or non-reinforcement learning, evolutionary algorithm, or deep learning techniques (convolutional neural networks, recurrent neural networks, long short-term memory networks, generative adversarial networks and or transformers) techniques may be applied. First robotic system 108 may receive input from sensors as described previously, and autonomously learn how to assemble output components 106 into robotic systems. Such an autonomously learned assembly configuration may be stored and recalled to assemble future robotic systems.

In some examples, system 100 may comprise a plurality of first robotic systems 108, wherein each first robotic system 108 may communicate with every other first robotic system 108 through a common communication network. In examples wherein first robotic systems 108 are autonomously operated, and employ machine learning/artificial intelligence methods, autonomously learned configurations may be shared between first robotic systems 108. For example, when a single first robotic system 108 autonomously learns a new configuration, this configuration may be shared with all like robotic systems across a common network, such that the learning process does not need to be undertaken by each first robotic system 108 in a network individually.

Second robotic system 106 may comprise any robotic system known in the art. Second robotic system 106 may include a robotic limb, a robotic arm, robotic leg, a humanoid robot, a non-anthropomorphic robot, a non-humanoid robot, a robotic vehicle, a robotic aircraft, a robotic spacecraft, a robotic watercraft, a manufacturing robot or any other robot type known in the art.

Output component 106 comprises any output component as previously described above.

The systems described herein may be configured such that robotic components of the robotic platform may be utilized to manufacture additional robotic components compatible with the robotic platform. For example, additional robotic components (and subcomponents thereof) may be additively manufactured (e.g. output component 106). Subsequent to manufacture of required sub-components, a robotic arm and/or manipulator based on the robotic platform described herein (e.g. first robotic system 108) may assemble the manufactured output components 106 (e.g. into second robotic system 110). Such a system may enable the platform to manufacture additional robotic systems as needed, expanding the capability of the platform. Additionally, such a system may enable the platform to grow, evolve and self-replicate as needed or desired, as long as additional source materials are available from material source 102. Similarly, robotic systems such as first robotic system 108 may be configured to self-repair and maintain using system 100.

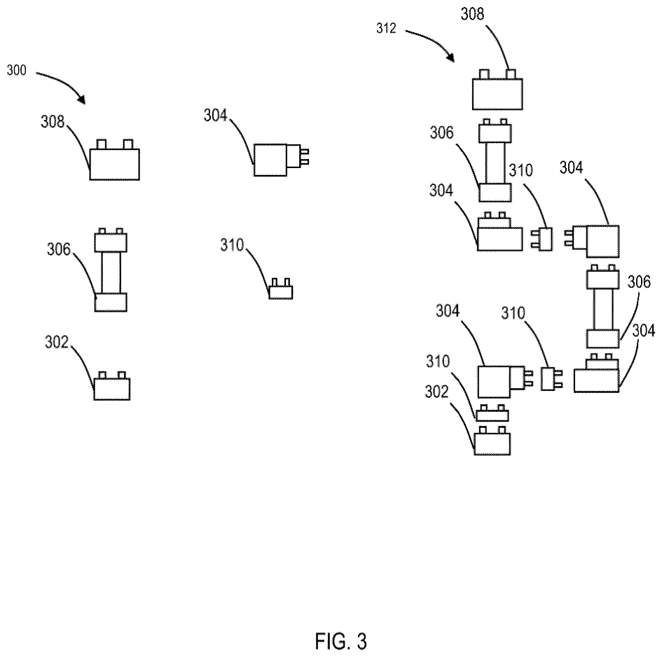

Referring now to FIG. 3, shown therein are the constituent components of a robotic platform 300, according to an embodiment. The platform 300 comprises standard component subtypes (base 302, joint 310, tee connection 304, linkage 206, and end effector 308), which may be coupled through common electrical and mechanical interfaces, such that these components may be chained into a variety of configurations. Such a platform enables robotic systems to be efficiently and flexibly constructed from the constituent components of the robotic platform. All constituent components of robotic platform 300 may be configured to be additively manufactured, as described above.

Base 302 comprises a mechanical component which may be secured to a surface, structure, or vehicle, and interface with other components through a joint 310, such that a robotic system based on robotic platform 300 may attach to a surface, structure, or vehicle. In some embodiments, multiple bases 302 may be exist, each with differing designs. For example, a first base 302 may include a suction cup base, such that the robotic system may be secured to a smooth surface with suction cups. In another example, a second base 302 may include a clamp, such that the robotic system may be secured to any clampable surface. Other base 302 designs may include mechanical fastener bases, compliant snap bases and other designs.

Joint 310 comprises a mechanical component which may enable the connection of components of robotics platform 300 to one another. Between any connection of robotic platform 300, a joint component 310 may be required. In some examples, each joint 310 may be fully internal to the robotic system to which it is applied, such that when the system is assembled, joints 310 are not visible. In other examples magnetic and/or electromagnetic systems may be used to connect robotic platform 300 to one another, using magnets and/or electromagnets.

Tee connection 304 comprises a one degree of freedom rotational tee joint. Tee connection 304 enables rotation along a rotational axis, such that the orientation of the components downstream and upstream of the tee 304 may be altered. Each tee connection 304 may include an internal motor or drive system, such that rotation of the rotational axis may be powered and controlled. In other examples, other joints may be used for connection such as swivel joints, universal joints, hinge joints, sliding joints, gimbal joints or flexure joints to enable a range of configurations and geometries.

Linkage 306 comprises a mechanical component which may extend the length of portions of the robotic system. Linkage 306 provides for no functionality other than increasing the length of portions of the robotic system in this embodiment. Electrical conductors may be routed within linkage 306 to maintain electrical communication lines across components. A plurality of linkage 306 components may be chained to one another to increase the total length of a portion of a robotic system. In other examples, linkages may be expandable and contracting linkages to extend range of operations, utilizing expanding grills, telescoping cylinders, multibar linkages, and/or nested slides or the like.

End effector 308 comprises any component which may be coupled to the robotic system to perform various functions. For example, end effector 308 may include a gripper end effector, screwdriver end effector or other end effectors to enable additional functionality. End effector 308 may be coupled to any other component of the platform 300 through a joint 310, or in some examples, directly.

All components of robotic platform 300 are configured such that they may be substantially additively manufactured.

Any number of such components may be chained together to create a variety of robotic systems. For example, multiple tee connections 304 may be included, which may enable additional maneuverability of the robotic system.

Robotic system 312 of FIG. 3 is an example embodiment demonstrating an assembled robotic system 312 based on robotic platform 300. Robotic system 312 includes one base 302, four tee connections 304, two linkages 306, one end effector 308 and three joints 310. Joints are not required between tee connections 304 and linkages 306 in robotics platform 300. Components may be assembled as shown in FIG. 3, to produce a robotic arm with an end effector 308.

In other embodiments, robotic platforms may include other types of constituent components. For example, a vehicle focused robotic platform may include standard interchangeable chassis, sensor set, cabin, drive wheel, drivetrain, and other robotic components, which may be altered or interchanged to change or increase functionality over time.

In some examples of robotic platform 300, the platform may include a standardized control and operation interface. Such an interface may be used to control the state of, and operate, a robotic system constructed from the constituent components of the robotic platform. The control interface may couple to a computer device, microcontroller or other device to receive input controls, or generate output controls from signals received from sensor systems. The control interface may pass sensor data back from the robotic system to a coupled control device, in examples wherein the robotic system comprises sensor systems. The control device may allow for additional robotic platform functionality, such as collision avoidance.

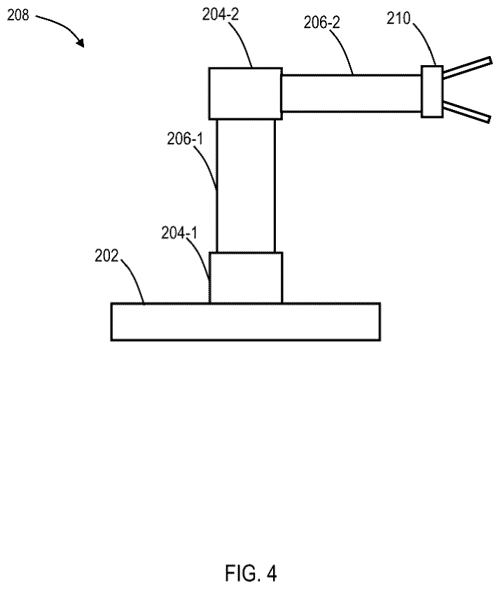

Referring now to FIG. 4, shown therein is a block diagram of a robotic system 208, according to an embodiment. Robotic system 208 is a robotic arm with a gripper type end effector. Robotic system 208 may correspond to first robotic system 108 of FIG. 2. Robotic system 208 is based on a robotic platform 300 of FIG. 3. Robotic system 208 includes a base 202, tee connections 204-1, 204-2, linkage 206-1, 206-2, and end effector 210. Joint components may be present within robotic system 208, but not visible in FIG. 4, as the joint components are internal.

Robotic system 208 may be used, as described in reference to system 100 above, to construct and assemble additional robotic systems, comprising additively manufactured constituent components based on a common robotics platform, such as platform 300.

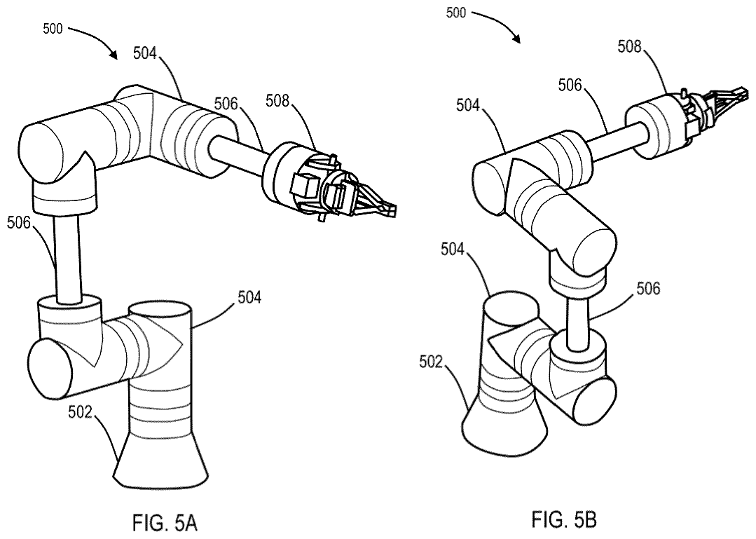

Referring now to FIGS. 5A, 5B, shown therein are two perspective views of a robotic arm 500 based on a robotic platform, similar to robotic platform 300 as described above. The robotic platform of the robotic arm 500 may differ from robotic platform 300. For example, the robotic platform of the robotic arm 500 does not include joint components. Robotic arm 500 includes a base 502, two tees 504, two linkages 506, and end effector 508. Description above in reference to other robotic systems (e.g. system 312) may apply to robotic arm 500.

Robotic arm 500 is based on a robotic platform that includes a standard double key mechanical interface to enable coupling of robotic components of robotic system. Separate joint components are not required, as are required in platform 300. Constituent components of the robotic arm 500 may be coupled together using the double key mechanical interface. Double key interface components may include male and female constituent components, which may mate to one another, without the use of tools or additional fasteners.

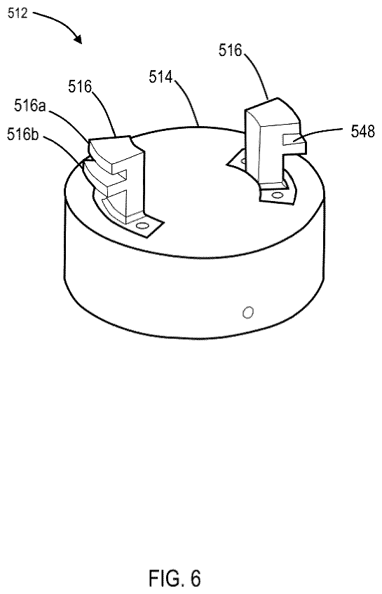

Referring now to FIG. 6, shown therein is a detail view of a male portion 512 of the double key mechanical interface. The component pictured in FIG. 6 comprises a base 514 and male double key 516.

The double key interface as described herein includes two male double keys 516. The male double key 516 comprises a generally perpendicular linear projection from base 514. Male double key further includes two rectangular teeth components, 516a, 516b, extending perpendicularly from the linear projection. Teeth components 516a, 516b are separated by a distance, such that an object that male double key 516 is engaging with may mate between teeth components 516a, 516b. This distance may be referred to as male recess 548. The male double key 516 may mate with corresponding female features of female double key interfaces.

In some examples, male double key 516 and base 514 may be constructed from different materials. As the male double key 516 may require greater material strength, male double key 516 may be constructed from a metallic, or other similarly strong material, such as laser sintered aluminum, while base 514 may be constructed from a polymer such as PLA or ABS.

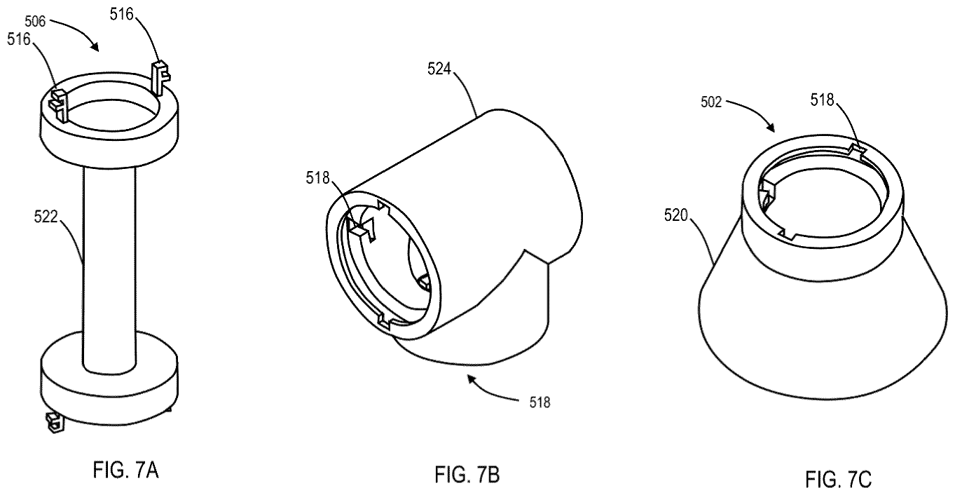

Referring now to FIGS. 7A-C, shown therein are detail views of portions of constituent components of robotic arm 500. FIG. 7A shows a linkage 506, FIG. 7B shows portions of tee junction 504 and FIG. 7C shows base 502.

Base 502 comprises a body 520 and a female double key interface 518. Base 502 may be used to couple robotic arm 500 to a substrate surface. For example, if robotic arm 500 is to be applied in a manufacturing context, base 502 may be coupled to the manufacturing facility floor, with bolts or other fasteners. The female double key interface 518 at the other end of base 502 may couple to components of robotic arm 500, or other components of the robotic platform on which robotic arm 500 is based.

Linkage 506 comprises a hollow generally cylindrical component including a body 522 and a male double key interface 516 at each end. Linkage 506 is generally symmetrical, wherein each interface end of linkage 516 is identical. The hollow body of linkage 506 may be used to pass electrical conductors through, such that electrical power and data may be passed through linkage 506.

Only a portion of the tee junction 504 is pictured in FIG. 7C. Tee junction 504 comprises tee body 524. At each end of tee body 524 is a female double key interface 518. Tee body 524 may be used to construct tee junctions 504 of a robotic arm, as seen in robotic arm 500 of FIG. 5. Tee body 522 is generally hollow, such that electrical conductors may be passed through. In some embodiments, tee body 524 may further include ventilation holes.

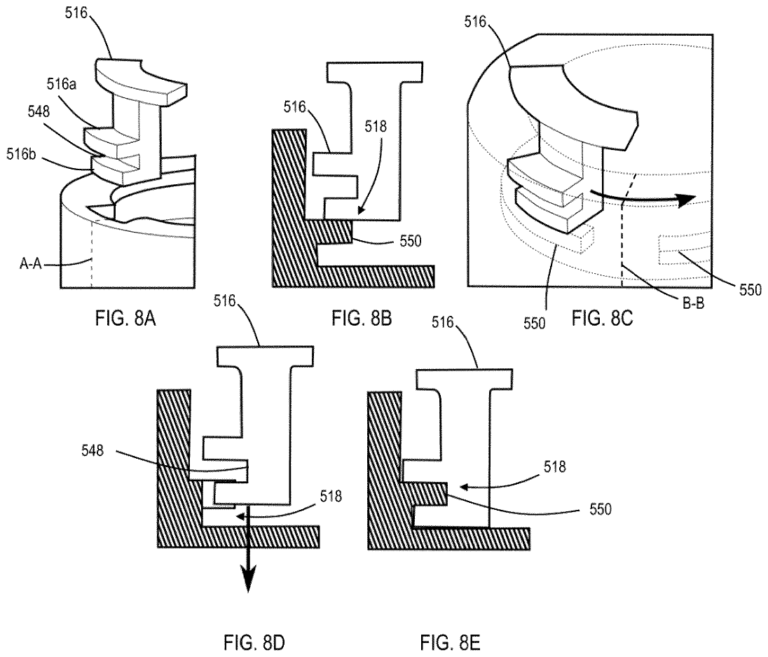

Referring now to FIGS. 8A-E, pictured therein are detail views of the double key interface during various stages of mating. FIGS. 8A-E are presented in sequential order of a mating process. In general, for the double key mechanical interface, a male part is inserted into corresponding slots for male double key components on a female part, until resistance is met. Next, the male part is rotated until the male double keys are aligned with a second set of slots, such that the male part may be pushed further into the female part. Finally, the male part may be rotate again to lock the male part to the female part.

At FIG. 8A, shown is a perspective view of a male double key 516 mating with a female double key interface. The male double key 516 is inserted into the slots on the female part until resistance is met.

At FIG. 8B, shown is a cross sectional view along section A-A of FIG. 8A, after male double key has been lowered into female double key interface 518. Male double key 516 may now be resting on female tooth 550.

At FIG. 8C, shown is a perspective view of a male double key 516 mating with a female double key interface. The male part may be rotated, until the male double key 516 aligns with a second female slot, between two female tooth 550 components. At this point, male double key 516 may be pushed further into the female double key interface.

At FIG. 8D, shown is a cross sectional view along section B-B of FIG. 8C. Male double key 516 is aligned with the second female slot between two female tooth 550 components. Male double key 516 may now be full inserted into the female double key interface.

At FIG. 8E, shown is a cross sectional view along section A-A of FIG. 8A, after male double key has been fully mated with the female double key interface 518. After the male double key 516 is in the position of FIG. 8D, the male double key may be further rotated such that the position of FIG. 8E is reached. In the final mated position, male teeth 516a, 516b are sandwiched around female tooth component 550, such that recess 548 is mated with female tooth component 550, securing the male portion to the female portion of the interface.

In some embodiments, a threaded hole may be provided across the mechanical interface, for receiving a set screw or spring plunger set screw.

At this stage, components are securely mated. To unmated components, an operator may simply perform the operation in reverse.

While only a single male double key 516 is shown in FIGS. 8A-E, the full mating process includes the mating of an interface including two male double keys 516 (as shown in FIG. 6), each 180 degrees opposed from one another. In other embodiments, more or fewer interface elements may be present.

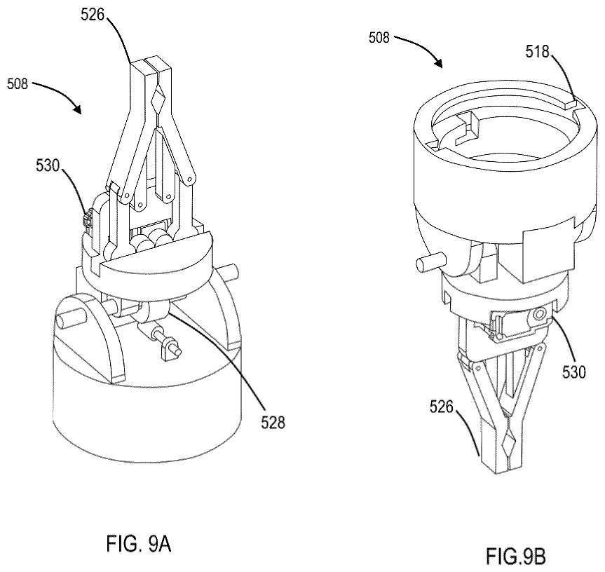

Referring now to FIGS. 9A and 9B, pictured therein are perspective views of end effector 508. End effector 508 includes worm drive system 528, jaws 528, female double key interface 518 and motor 530. End effector 508 is configured such that female double key interface 518 may couple to another component of robotic arm 500, wherein the other component includes a male double key interface. In the embodiment of FIG. 5, end effector 508 is coupled to a linkage 506 to connect end effector 508 to the robotic arm 500.

End effector 508 is a grapple type end effector. Jaws 528 of the end effector may be opened and closed around objects, applying a force to an object, such that the object may be lifted and manipulated in space by the robotic arm 500. Jaws 528 may be clad with silicone or another grippy material to increase jaw friction and therefore end effector 508 performance. End effector 508 may grasp and lift an object with a mass of up to 1.5 kg and diameter of up to 101.6 mm in this embodiment. End effector 508 may be largely constructed from ABS polymer.

In some examples of end effector 508, force sensors, such as strain gauges or force sensitive resistors, may be integrated into jaws 528, to enable force feedback to be delivered to a control system associated with the robotic system. Such force sensors may enable more precise operation, and/or haptic feedback. For example, force sensors may allow the robotic system to determine how much gripping force is applied to a grappled object, enabling a controlled amount of gripping force to be delivered, which may enable to end effector 508 to grapple more delicate, light objects, without damaging such objects.

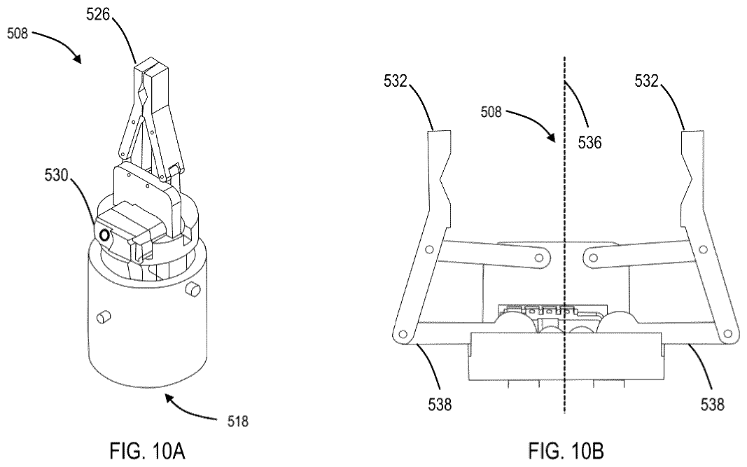

Referring now to FIGS. 10A and 10B, pictured therein are perspective views of end effector 508, in a closed position and open position respectively. Worm drive system 528 may be driven by motor 530 to switch end effector 508 between the open and closed position, or an intermediate position. When end effector 508 is in the closed position, motor 530 may rotate, rotating worm drive system 528, and separating jaw members 532 open. Each jaw member 532 comprises a bar within a four-bar linkage. As the worm drive system 528 rotates, lower linkage members 538 rotate away from the center axis 536 of end effector 508, and jaw members 532 are pulled open, away from center axis 536 of end effector 508, placing end effector 508 into the open position as pictured in FIG. 10B.

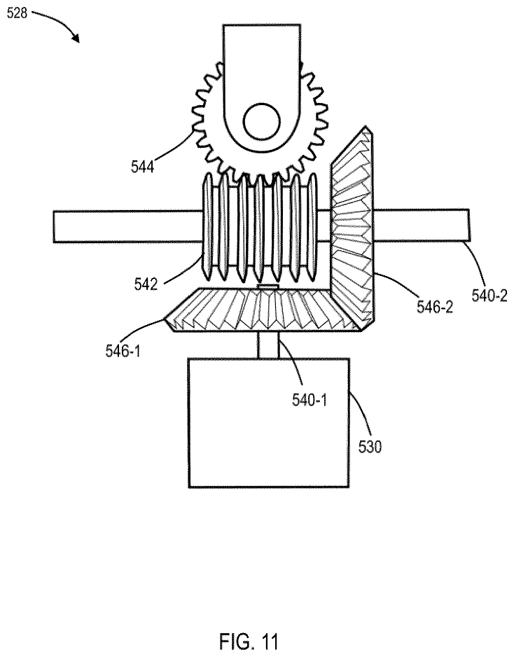

Referring now to FIG. 11, pictured therein is a detail view of worm drive system 528 of end effector 508. Worm drive system 528 further includes motor 530, shaft 540-1, 540-2, bevel gears 546-1, 546-2, worm screw 542 and output worm gear 544. Shaft 540-1 is driven by motor 530, such that shaft 540 rotates, rotating bevel gear 546-1. Bevel gear 546-1 rotates bevel gear 546-2, which rotates shaft 540-2.

Shaft 540-2 is coupled to, and rotates, worm screw 542. In turn, worm screw 542 rotates worm output gear 544, such that the axis of rotation is now perpendicular to the axis of rotation of the worm screw 542. Worm output gear 544 may now rotate lower linkage members 538 to open jaws 526, as described above. The amount of rotation of motor 530 may be controlled to precisely control the state (open, closed, intermediate) of end effector 508.

The worm drive system 528 provides for 1:1 gear ratio bevel gears and a 16:1 gear ratio worm to gear worm drive. Worm drive system 528 may be constructed from PLA polymer.

In some embodiments of robotic arm 500, end effector 508 may provide for different functionality, or end effector 508 may be replaced with another end effector that provides for different functionality. For example, an end effector with an integrated cleaning tool may be coupled to robotic arm 500.

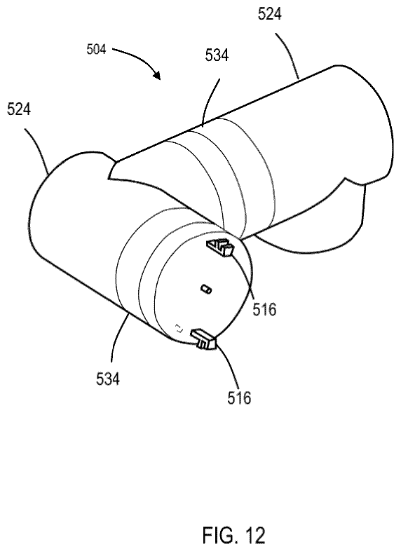

Referring now to FIG. 12, shown therein is tee 504 in greater detail. Tee 504 comprises two rotational degrees of freedom, wherein the two segments of the tee 504 may be moved independently to one another. Each tee 504 comprises two tee bodies 522, and two rotational junctions 534.

Each rotational junction 534 may comprise internal gearsets, motors and electrical circuity to enable the rotational junction 534 to rotate about a central axis. Additionally, each rotational junction 534 includes mechanical interface components (male double keys 516) to allow for interoperability with other components of the robotic platform (e.g. mechanical linkages).

Tees 504 may be arranged to enable certain functionality of the robotic system on which robotic arm 500 is based. The tee 504 as pictured includes two tee bodies 524 and two rotational junctions 534 at perpendicular arrangements to one another. This enables two degree of freedom rotational motion of the tee 504 along two perpendicular rotational axes. In some embodiments, tee 504 may further comprise ventilation holes, and or electric fans, to promote heat transfer away from internal motors and circuitry.

Tee 504 may include temperature sensors, encoders, and 3-position switches.

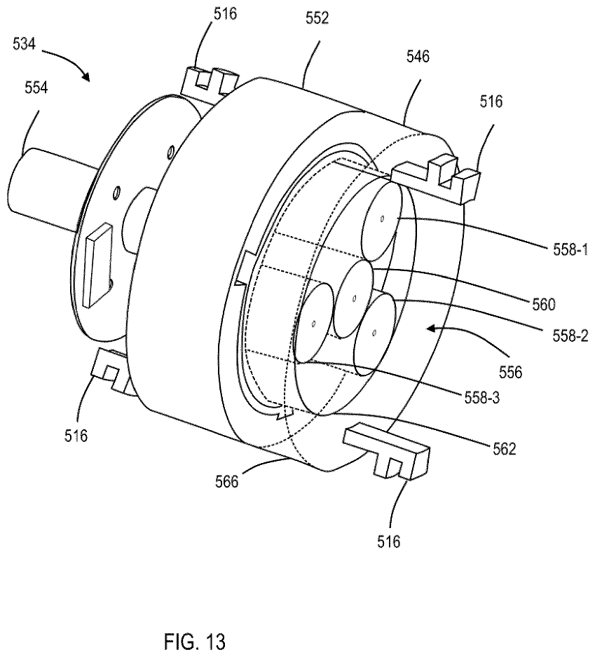

Referring now to FIG. 13, pictured therein is a perspective view of a rotational junction 534. Rotational junction 534 includes gearset enclosure 546 and motor enclosure 552. Rotational junction 534 is pictured in FIG. 13 partially exploded, wherein the rear panel of motor enclosure is removed. Additionally, gearset enclosure 546 is shown partially transparent, and gears of planetary gear system 556 are shown in simplified form, with gear teeth not pictured, to promote clarity. In embodiments of rotational junction 536, planetary gear system 556 includes toothed gears.

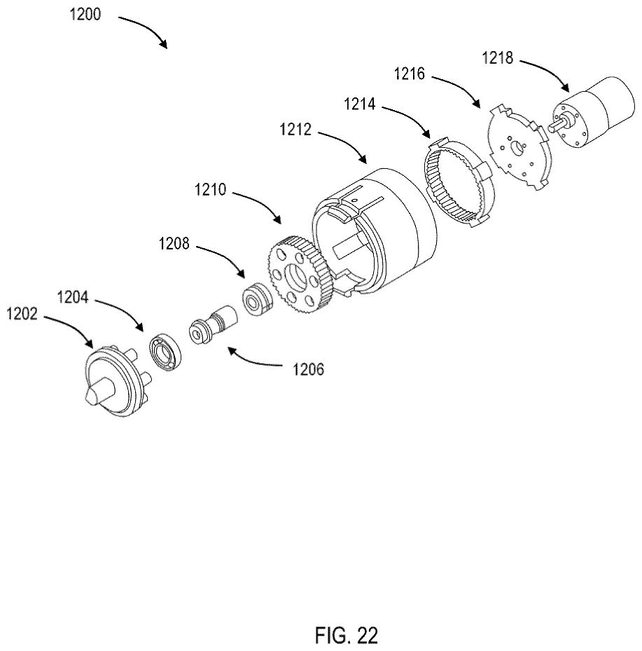

In some embodiments, a cycloidal gearbox system may be applied instead of a planetary gearbox system, to improve performance characteristics. A cycloidal gearbox may minimize size and ease additive manufacturing. Cycloidal gearbox may be cycloidal gearbox 1200 of FIG. 22, including an output component 1202, bearing 1204, eccentric shaft 1206, collar 1208, gears 1210, housing 1212, ring gear 1214, plate 1216, and motor 1218. In some embodiments, the cycloid gearbox may be a cycloidal disc gearbox, cycloidal needle gearbox, dual-input cycloidal gearbox, coaxial cycloidal gearbox, differential cycloidal gearbox, planetary cycloidal gearbox or the like. The cycloidal gearbox design may be modified depending on user driven criteria and or inputs or determination by artificial intelligence or machine learning techniques based on torque requirements, speed reduction ratio, space constraints, and other application characteristics, as such may employ inline and right-angle configurations allowing for flexibility in system design and integration, hollow shaft designs where input and output shafts can pass through the center of the gearbox, backlash reduction where the clearance between gear teeth is optimized, high torque densities to enable higher ranges of torque, integrated motor options eliminating the need for separate motor mounting and coupling, corrosion resistance and/or noise reduction features.

Each end of rotational junction includes male double key 516 features, such that rotational junction may mate with female double key interfaces at each end.

Motor 554 is shown partially removed in the partially exploded view of FIG. 13. When assembled, motor 554 is within the envelope of motor enclosure 552. Motor 554 drives planetary gear system 556, which imparts rotation into the rear panel of gearset enclosure 546, such that rear panel and motor enclosure 552 rotate relative to one another.

Motor 554 may be a brushed 12V DC gear motor with an encoder, with a rated torque of 1 N*m, and a no load speed of 251 RPM +/−10%. Motor 554 may differ in other embodiments.

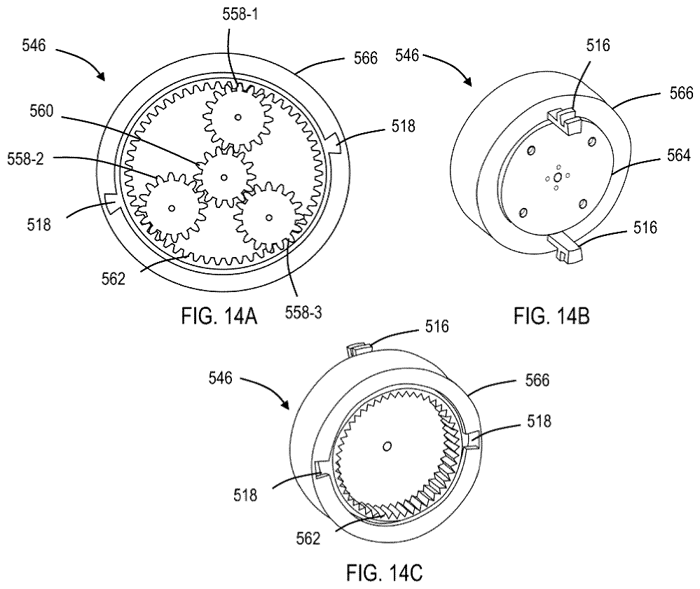

Planetary gear system 556 includes sun gear 560, planet gears 558-1, 558-2, and 558-3, and ring gear 562. The shaft of motor 554 is coupled to sun gear 560, which may rotate planet gears 558-1, 558-2, and 558-3, which rotates ring gear 562. Ring gear 562 is fixed to gearset enclosure 546 rear panel 564 (pictured in FIG. 14B), such that when ring gear 562 rotates, gearset enclosure 546 rear panel 564 rotates, generating relative rotation of gearset enclosure 546 rear panel 564 and motor enclosure 552 as described above.

The gear system may provide a gear ration of 50:1 in some embodiments.

Referring now to FIGS. 14A-C, pictured therein are detailed views of a gearset enclosure 546. Gearset enclosure 546 includes a planetary gear system. FIGS. 14A-C show planetary gear system with gear teeth pictured. While certain numbers of gear teeth are visible in FIG. 14A-C, number of teeth may vary depending on embodiment parameters, such as motor specifications, torque requirements, materials strength and more.

Shown in FIG. 14A is a frontal view of planetary gear system 556. Sun gear 560 meshes with planet gears 558-1, 558-2, 558-3, rotating the planet gears, which in turn rotate ring gear 562. Ring gear 562 is fixed to rear panel 564, such that when ring gear 562 rotates, body 566 rotates.

Shown in FIG. 14B is a rear perspective view of gearset enclosure 546. Visible in FIG. 14B is rear panel 564 and male double key features 516. Rear panel 564 and male double key features 516 are coupled to one another, such that rear panel 564 and male double key features 516 may rotate relative to body 566.

Shown in FIG. 14C is planetary gear system 556, with planet and sun gear removed.

While a single planetary gear system is shown herein, in some embodiments, multiple planetary gear systems may be placed in series to adjust gear ratios.

While not pictured in the embodiment of FIGS. 5-14, some embodiments of robotic arm 500 may further include a standardized electrical communication interface. For example, each constituent component of the robotic platform may include a set of spring loaded electrical contacts that are aligned and coupled when components are mated. These electrical contacts may carry electrical power and data signals.

In embodiments without a standardized electrical communication interface, electrical conductors may be run from the base, through the robotic system, to the end effector, to provide components with electrical power, control sensors, and receive sensor feedback.

The embodiment of FIGS. 5-14 is configured to receive electrical power for operation through an electrical conductor. In other embodiments, robotic systems based on robotic platforms as described herein may be powered with stored energy. Stored energy may comprise batteries, such as lithium batteries, fuel cells or the like.

In other embodiments, robotic systems based on robotic platforms as described herein may be powered wirelessly. Wireless power schemes may include inductive power, magnetically coupled power transfer, directed electrical power transmission, thermal power systems (thermionic emission, thermophotovoltaic (TPV), and thermoelectric or the like, laser power transmission, maser power transmission, infrared power transmission, or terahertz band radio frequency power transmission. In some examples, wireless power schemes may be used to charge energy storage devices within the robotic arm 500, such as TPV systems, lithium batteries and/or capacitors.

In some embodiments of the robotic systems described herein, the systems may be configured to be operated autonomously.

In some embodiments of the robotic systems described herein, a plurality of robotic systems may be deployed as a single robotic system network. The single robotic system network may be operated autonomously, utilizing artificial intelligence and machine learning methods. When a single robotic system of the network acquires new knowledge, this knowledge may be shared across the entire network, such that all robotic systems of the network may learn from all events that occur across the entire network.

In some embodiments of the robotic systems described herein, the systems may be configured to utilize separated artificial intelligence-based control systems for functionality and/or operation. For example, one or more components of the robotic system are driven by independent Al systems, and they coordinate and interact with each other to optimize control and operations.

In some embodiments of the robotic systems described herein, the systems may be configured to be operated by a human operator interfacing with a remote terminal. For example, such a system may be deployed in a healthcare setting. Such a system may be employed in general nursing duties. A human nurse at a remote location may operate such a system through a video terminal. In some embodiments, the video terminal may comprise a extended reality (virtual reality, augmented reality or mixed reality) system. Human nurses may operate the nursing robot remotely. Human nurses may operate the nursing robot in shifts, wherein the operator is switched at regular intervals (e.g. every 8 hours) to allow for operator rest, and continuous operation of the system.

The present systems, devices, and methods provide for multi-purpose, multi-axis interchangeable robotics. Modules may be additively manufactured. Robotic modules may be applied to humanoid robotics. Robotic systems may comprise intelligence and real time control systems. Haptic feedback, both primary and secondary, may be integrated into systems to provide for greater interactions. In some examples, robotic systems described herein may be nature and/or bio-inspired. In some examples, robotic systems may include robotic joints. Robotic systems described herein may be applied to services as fixed and/or mobile platforms, and may operate in extreme environments, on Earth and in Space. Robotic systems described herein may be applied to managing assets and activities using a plurality of robotic systems. A network of robotic limbs may be produced using the systems and methods described herein.

In some embodiments, the robotics systems are used to augment and or support human workers through autonomous and/or semi-autonomous operations, where a remote operator may control the robotic system to assist the human worker to perform tasks. The robotic system may learn while performing tasks to improve operations using artificial intelligence and or machine learning techniques.

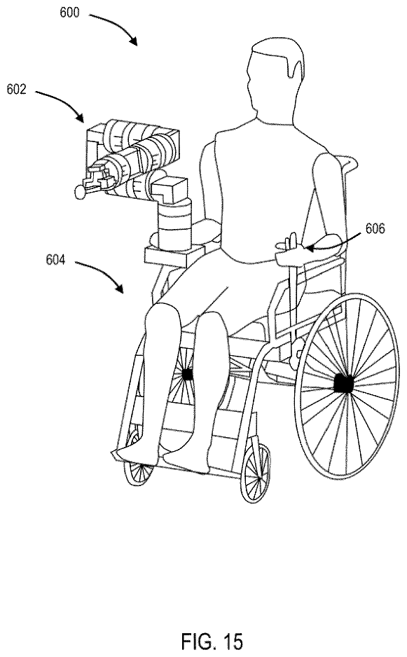

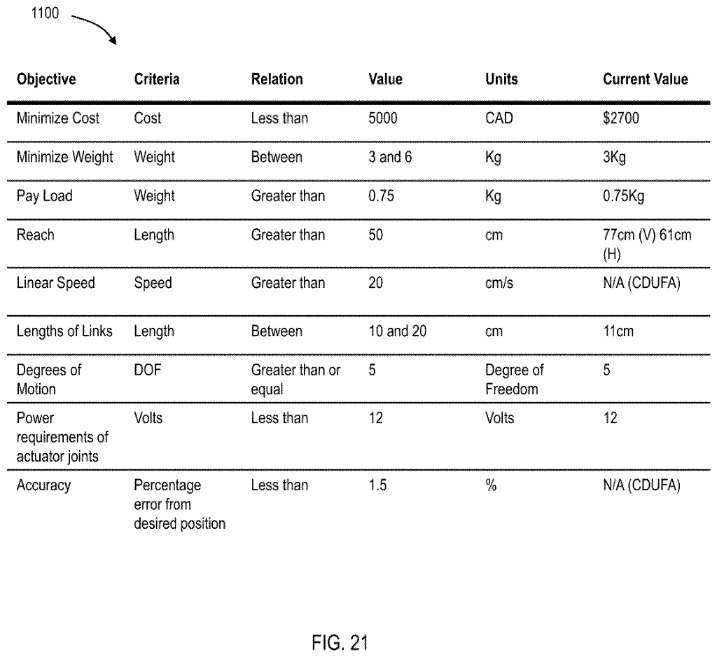

In some embodiments of the present disclosure, the systems and methods described may be applied to assistive technology devices. Referring now to FIG. 15 shown therein is a robotic system 600, applied as an assistive technology device. Robotic system 600 includes a 5-link (5 DOF) robotic arm 602, with replaceable end effectors 608. Robotic arm 602 is coupled to a wheelchair 604. The end-user of the wheelchair may operate a control 606, which may enable an end-user to manipulate the robotic arm 602. In some examples, control may be referred to as a human input device. System 600 may conform to specifications as outlined in table 1100 of FIG. 21.

The system 600 may be of particular use to individuals with partial loss of motor control or strength. For example, such a system 600 may be applicable to individuals with motor control or strength loss from multiple sclerosis or stroke.

Multiple sclerosis affects every 290 per 100,000 people in Canada, and 66% of people with multiple sclerosis have a degree of upper limb disabilities that effect daily living activities, leading to weakness, poor coordination and balance difficulties. One third of multiple sclerosis patients are in wheelchairs 1-2 decades post diagnosis.

Stroke affects 800,000 people per year in Canada, and 77% of stroke survivors have upper limb problems, leading to spasticity, lack of fine motor skills and fatigue.

Individuals with partial motor control or reduced strength may manipulate control 606. Movement of control 606 may be proportional to movement of robotic arm 604, such that the end user may control robotic arm 604, enabling the end user grasp and move objects.

End effector 608 comprises a compliant type gripper end effector, wherein links may deform as end effector 608 opens and closes to grasp objects. End effector 608 includes a range of motion ranging from −90° to +20°.

In some embodiments, control 606 may comprise a physical joystick. The joystick may be manipulated by the user to arrange the robotic arm 602 in 3D space. In some embodiments, control 606 may include haptic feedback, such that physical feedback may be delivered back to the end user through the control 606, enabling the end user to feel or detect limits of motion of the robotic arm 602, or feedback from force sensors integrated into the end effector (for example, into jaws 528 of end effector 508). The physical joystick may further include pressure pad sensors to modulate end effector gripping force and or LEDs for test and visual cues that an object has been picked up.

In other embodiments, control 606 may comprise a head mounted display, virtual reality headset, eye control system, blink control system, and/or brain computer interface. Brain computer interfaces may include invasive and non-invasive brain computer interfaces.

In embodiments including manual control, Robotic system 600 may be augmented with a collision avoidance system. The robotic arm 602 may be manipulated with control 606. The collision avoidance system may be preprogrammed with invalid configurations, wherein components of the system may collide. The collision avoidance system may prevent such motions of the robotic arm 602, even when prompted by control 606.

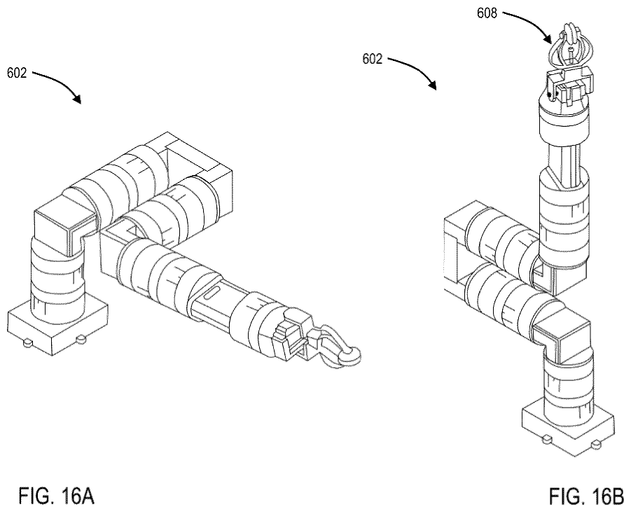

Referring now to FIGS. 16A and 16B, shown therein are additional perspective views of robotic arm 602. The robotic arm 600 may correspond to the robotic arm of FIGS. 5A and 5B.

While the shown assistive device embodiment comprises a shoulder/arm style robotic arm, in other embodiments, other assistive devices may be constructed. For example, robotic limbs such as arms, and legs, or robotic joints may be constructed.

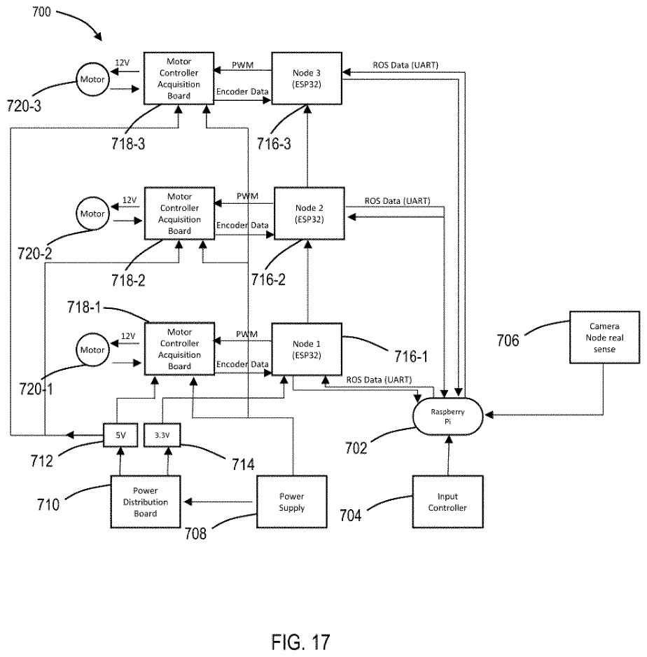

Referring now to FIG. 17, shown therein is an electrical schematic broadly detailing the electrical layout 700 of the robotic system 600. The system is generally controlled by a Raspberry Pi 702 single board computer, which delivers control signals to ESP32 microcontroller modules 716-1, 716-2, 716-3, which modulate and control motor output through motor controller acquisition boards 718-1, 718-2, 718-3 for each motor 720-1, 720-2, 720-3. An input controller 704 (e.g. control 606) is coupled to the Raspberry Pi 702 computer, to provide inputs. Power is provided from an ATX format power supply 708, providing a 3.3V rail 714 and 5V rail 712, as well as a 12 rail. The system 700 may further include a camera 706, which may be applied by system 700 to implement a computer vision-based object collision avoidance feature, wherein the robotic system 600 may not be directed to collide with other objects without the control system overriding this input.

In other embodiments, other electrical system layouts and designs may be utilized to control and operate the robotic systems and platforms as described herein.

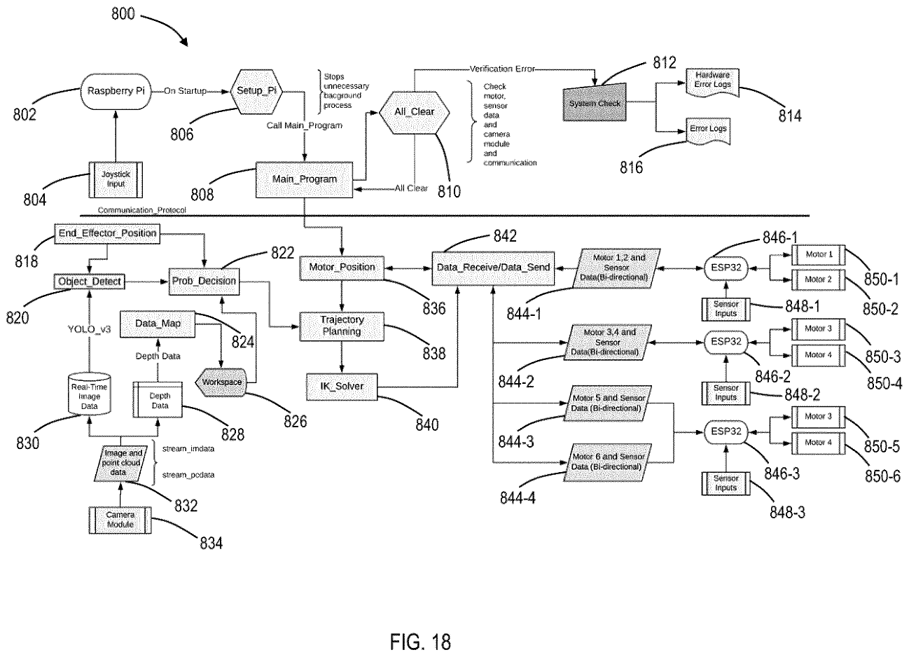

Referring now to FIG. 18, shown therein is a schematic 800 detailing the software architecture of the control system for robotic arm 600, according to an embodiment. The control system detailed in the schematic 800 of FIG. 18 enables the collision avoidance functionality of the robotic arm 602 as previously described. In other embodiments, other software schemes and control systems may be used to operate and control robotics systems.

Schematic 800 includes Raspberry Pi 802. The Raspberry Pi 802 is the primary computing device on which the system of schematic 800 is operating. Raspberry Pi 802 may execute the main software systems. Setup_Pi 806 may be executed to initialize the software system. Setup_Pi 806 may then call main_program 808. Main_program 808 may check system status through system check 812. If any errors are detected, system check 812 may output hardware error logs 814 and error logs 816. If no errors are detected, or errors have been resolved, main_program 808 may receive an all_clear 810 input to indicate that no errors are outstanding.

All communications between main_program 808 and lower-level components may be conducted through a custom communication protocol according to some embodiments.

Main_program 808 may call motor position 836 to read or change current motor position of all robotic arms. To read motor position, data_receive/data_send module 842 may receive motor sensor data from motor sensor data modules 844-1, 844-2, 844-3. Motor sensor data modules 844-1, 844-2, 844-3, 844-4 are coupled to ESP32 microcontrollers 846-1, 846-2, 846-3, which receive sensor data from sensor input modules 848-1, 848-2, 848-3.

To change motor position, main_program 808 may call motor_position module 836 to set a new position, as per input from joystick input 804. This input data may be passed to trajectory planning module 838.

Trajectory planning module 838 may additionally receive input for collision avoidance purposes. Camera module 834 may receive image data from a camera. This data may be in the form of image and point cloud data 832. Image and point cloud data 832 may be converted to real-time image data 830 and depth data 828.

Data_map 824 may be generated from depth data 828 and provided to workspace 826. Workspace 826 may further provide information from Data_map 825 to pro_decision module.

Real-time image data 830 may be processed using a YOLO_v3 function, and provided to object_detect module 820. End_effector_position module 818 data may detail end effector position, and provide this position data to object_detect 820 module and prob_decision module 822. Prob_decision module may then pass collision avoidance data to trajectory planning module 838.

Once this collision avoidance data is received from prob_decision module 822, trajectory planning module 838 may pass trajectory data to IK_solver module 840, which may generate an inverse kinematics solution to generate motor input commands. Motor input commands may be passed to data_receive/data_send module 842, which may be passed to ESP32 microcontrollers 846-1, 846-2, 846-3, through motor sensor data modules 844-1, 844-2, 844-3, 844-4. ESP32 microcontrollers 846-1, 846-2, 846-3 may finally pass motor control signals/input commands to motor 850-1, 850-2, 850-3, 850-4, 850-5, 850-6 as needed.

The software system described herein may utilize OpenCV, Numpy, RosPy, RosSerial, pyserial, SciPy, and socket Python libraries, ROS, as well as Movelt framework software.

The Movelt framework is an open-source framework that is extensively used to control robots in both a simulated and real-world environment. The Movelt framework has a variety of functions that can range from core functions like Inverse Kinematic solvers to perception modules. Assigning each joint, links, their limit properties and their relationships is done by creating a RobotModel from the robot description via the URDF file. The information from the RobotModel can be used to plan a path from the end effector to the pose goal, plan and execute the trajectory calculations while taking into account the manipulability measures and also avoid collisions of the robot arm with its respective joints. Information regarding the objects in the workspace can be passed on to built-in functions of Movelt to compute the plan to the goal location and execute it. Collision update messages can be received as the robot is in motion and with the addition of an object collision and avoidance system can make use of the extra objects in the workspace to update the trajectory calculation functions to alter the path of travel.

Collision and obstacle avoidance are functions that are implemented in the control system to avoid joints and links from colliding with each other or collision of joints and links with external objects in the robotic arms environment. Collision avoidance with joints and links in the robot can be verified via a Movelt function—“collision-aware IK”. This function has now specified to the inverse kinematics solver to find a collision-free solution for the desired end effector pose. In addition to this we can include information from a Depth camera (Real Sense RGBD camera) to store and identify an object and its position with respect to the robot arm. The camera will be located above the user and information will be relayed to the perception pipeline in Move_It and stored as PointClouds (XYZ information). Information from each PointCloud will be used to create an OctoMap which is an efficient probabilistic 3D mapping framework based on Octrees. The control system will be developed as a redundant system so that each sensor can verify the data obtained with each other and minimize the possibility of collisions with objects in 3D space. A collision and obstacle avoidance system increase the safety of the objects in the operating environment and changes the arm trajectory as new objects are added to the system. This reduces possible collisions with obstacles and avoid them while the robotic arm is in motion. In the event of collision with an object back drivability measures are implemented. This method takes into account the response from the control system and obstacle avoidance system to retrace the arm a few steps back, update the current scene of the robot to correct errors in total objects detected, recalculate the current position and wait for the user's input to move to the next position.

The YOLO model (You Only Look Once) is a method of detecting object in the scene. The model looks at an entire image once, goes through the network once and then detects objects. A pre-trained YOLO model with OpenCV will be used to detect objects and the pretrained weights can predict majority of objects with ease. A few objects specific to our implementation will be used to train and test the networks predictions to be able to detect those specific objects. This method of probability object selection helps the trajectory planning functions to prune paths towards different objects in the scene by using the distance from the objects in the scene to the pose of the end effector. This method simplifies the trajectory calculation and inverse kinematics calculation.

A teleoperation platform may be implemented via a basic webhosting service. A barebones locally hosted webservice with a database system to store and send user inputs from a joystick will be used to teleoperate the robotic arm. This system may be setup locally for prototyping and can be expanded to an online platform that can be accessed from anywhere. The website may have a display of the stream from the camera via the Raspberry Pi and legends to indicate how the user should move the joystick to control the robot. The joystick inputs may be fed in through a serial protocol and the command inputs will be stored in a database system. This database system may then send the joystick position information to the Raspberry Pi which may be used to move the robotic arm. The stream that is sent from the camera to the web platform enables the user to view the scene that the robotic arm is currently in and move the end effector to different locations via the joystick input. Since, the camera will be placed above eye level, the user that is teleoperating the arm can see the entire arm in motion and the different objects in the scene.

In other embodiments, other control system software layouts and designs may be utilized to control and operate the robotic systems and platforms as described herein.

While the description above has highlighted embodiments applied to assistive devices, the systems and methods described herein may be applied to a wide range of applications. The systems and methods described herein may be applied to medical devices, such as surgical and healthcare robotics, augmenting mobility for individuals, minimally invasive surgical robots, in situ and monitoring operations on land, air, water and space, service and repair operations, manufacturing, assembly and disassembly robots, operator augmentation robotics, and robotics applied to the measurement, tracking, monitoring, training and evaluation of operators.

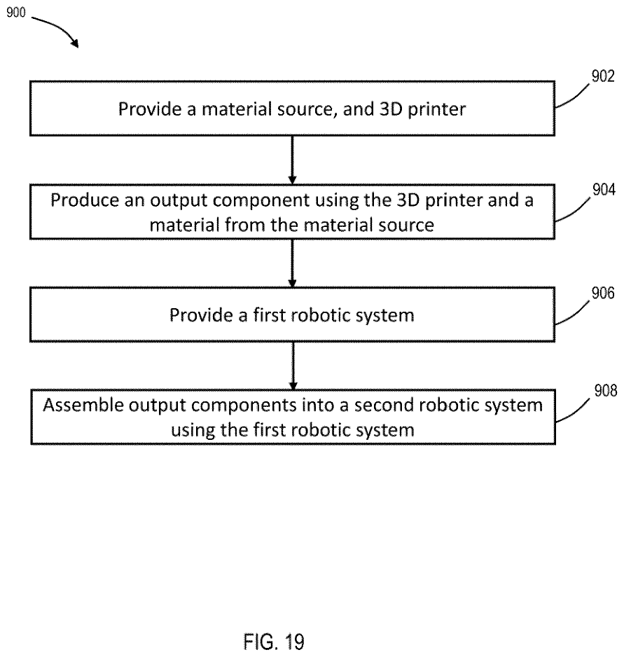

Referring to FIG. 19, illustrated therein is a flow chart depicting a method 900 of manufacturing robotic components, based on a robotic platform. The method includes steps 902, 904, 906, and 908. In some examples, the steps of method 900 may be performed in any order.

At 902, a material source, and 3D printer are provided.

At 904, an output component is produced using the 3D printer and the material source.

At 906, a first robotic system is provided.

At 908, output components are assembled into a second robotic system using the first robotic system.

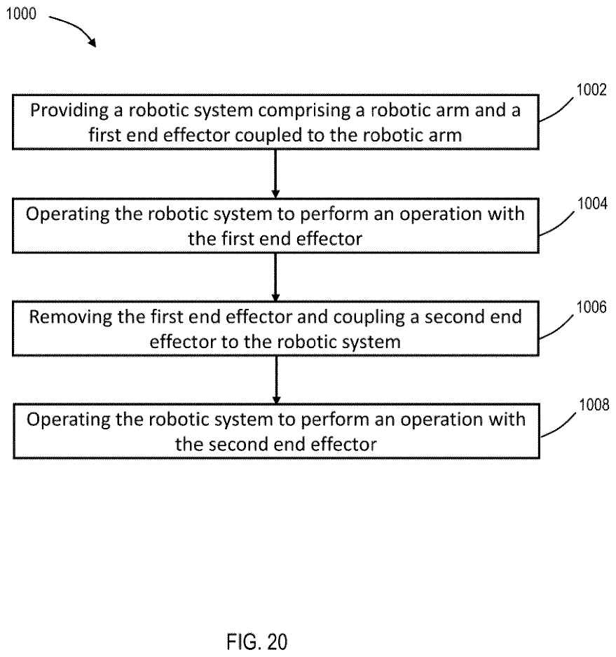

Referring to FIG. 20, illustrated therein is a flow chart depicting a method 1000 of operating a robotic system, based on a robotic platform. The method 1000 includes steps 1002, 1004, 1006, and 1008. In some examples, the steps of method 1000 may be performed in any order.

At 1002, a robotic system comprising a robotic arm and a first end effector coupled to the robotic arm is provided.

At 1004, the robotic system is operated to perform an operation with the first end effector.

At 1006, the first end effector is removed and a second end effector is coupled to the robotic system.

At 1008, the robotic system is operated to perform an operation with the second end effector.

While the above description provides examples of one or more apparatus, methods, or systems, it will be appreciated that other apparatus, methods, or systems may be within the scope of the claims as interpreted by one of skill in the art.

1. A robotic system, the system comprising:
a base;
a linkage;
a tee joint; and
an end effector;
wherein the base, the linkage, the tee joint, and the end effector comprise a standard mechanical interface, such that the base, the linkage, the tee joint, and the end effector are configured to mechanically couple to one another, and wherein the base, linkage, tee joint and end effector are additively manufactured.

2. The robotic system of claim 1, wherein the base, the linkage, the tee joint, and the end effector comprise a standard electrical interface, wherein that the base, the linkage, the tee joint, and the end effector are configured to be electrically coupled to one another, such that electrical power and data is passed between the base, the linkage, the tee joint, and the end effector when assembled.

3. The robotic system of claim 1, wherein the robotic system comprises an assistive device.

4. The robotic system of claim 1, wherein the robotic system is coupled to a wheelchair.

5. The robotic system of claim 1, wherein the base, the linkage, the tee joint, and the end effector are substantially constructed from PLA polymer.

6. The robotic system of claim 1, wherein the tee joint comprises two rotational degrees of freedom.

7. The robotic system of claim 1, wherein the tee joint comprises a planetary gear drive system.

8. The robotic system of claim 1, wherein the tee joint comprises at least one electric motor.

9. The robotic system of claim 1, wherein the robotic system is at least partially controlled by a human input device.

10. The robotic system of claim 1, wherein the human input device is configured to provide haptic feedback to an end user.

11. The robotic system of claim 10, wherein the haptic feedback corresponds to the output of a force sensor integrated into the end effector.

12. The robotic system of claim 1, wherein the end effector comprises a mechanical gripper.

13. The robotic system of claim 1, wherein the robotic system is autonomously operated.

14. The robotic system of claim 1, wherein the robotic system applies artificial methods during autonomous operation.

15. The robotic system of claim 1, wherein the robotic system communicates with a second robotic system over a communication network.

16. The robotic system of claim 1, wherein the robotic system further comprises a control interface.

17. The robotic system of claim 1, wherein the robotic system is controlled by an end user operating a remote terminal.

18. The robotic system of claim 17, wherein the remote terminal includes an extended reality system, which may include mixed reality, virtual reality, and/or augmented reality operations.

19. The robotic system of claim 1, wherein the robotic system is configured to receive wireless power.

20. A method of manufacturing a robotic system, the method comprising:
providing a material source and 3D printer;
producing an output component using 3D printer and a material from the material source, providing a first robotic system and assembling the output component into a second robotic system using the first robotic system.

21. The method of claim 20, wherein the output component comprises multiple output components.

22. The method of claim 20, wherein the second robotic system comprises an assistive device.

23. The method of claim 20, wherein the second robotic system is coupled to a wheelchair.

24. The method of claim 20, wherein the first robotic system and second robotic system are substantially constructed from PLA polymer.

25. The method of claim 20, wherein the second robotic system is at least partially controlled by a human input device.

26. The method of claim 25, wherein the human input device is configured to provide haptic feedback to an end user.

27. The method of claim 20, wherein haptic feedback corresponds to the output of a force sensor integrated into an end effector.

28. The method of claim 20, wherein the first robotic system is autonomously operated.

29. The method of claim 20, wherein the first robotic system applies artificial intelligence and/or machine learning methods during autonomous operation.

30. The method of claim 20, wherein the first robotic system communicates with another robotic system over a communication network.

31. The method of claim 20, wherein the second robotic system is configured to be controlled by an end user operating a remote terminal.

32. The method of claim 31, wherein the remote terminal includes an extended reality system, which may include mixed reality, virtual reality, and/or augmented reality operations.

33. The method of claim 20, wherein the first robotic system is configured to receive wireless power.

34. A method of operating a robotic system, the method comprising:
providing a robotic system comprising a robotic arm and a first end effector coupled to the robotic arm;
operating the robotic system to perform an operation with the first end effector;
removing the first end effector and coupling a second end effector to the robotic arm;
wherein the second end effector provides for different functionality than the first end effector and operating the robotic system to perform an operation with the second end effector.

35. The method of claim 34, wherein the robotic system is configured such that it may be additively manufactured.

36. The method of claim 34, wherein the robotic system comprises an assistive device.

37. The method of claim 34, wherein the robotic system is configured to be coupled to a wheelchair.

38. The method of claim 34, wherein the robotic system is substantially constructed from PLA polymer.

39. The method of claim 34, wherein the robotic system is at least partially controlled by a human input device.

40. The method of claim 39, wherein the human input device is configured to provide haptic feedback to an end user using tactile and/or kinesthetic methods.

41. The method of claim 34, wherein haptic feedback corresponds to the output of a force sensor integrated into the first end effector.

42. The method of claim 34, wherein the robotic system is autonomously operated.

43. The method of claim 34, wherein the robotic system applies artificial intelligence and/or machine learning methods during autonomous operation.

44. The method of claim 34, wherein the robotic system communicates with another a plurality of robotic systems over a communication network.

45. The method of claim 34, wherein the robotic system is configured to be controlled by one or more users operating a remote terminal.

46. The method of claim 45, wherein the remote terminal includes an extended reality system, which may include mixed reality, virtual reality, and/or augmented reality operations.

47. The method of claim 46, wherein digital twins of operations may be utilized in the extended reality system to support training of operators, and/or support training of robotic systems utilizing artificial intelligence and machine learning techniques.

48. The method of claim 46, wherein digital twins of operations may be utilized in the extended reality system to support maintenance schedules and or replacement of robotic systems where a first robotic systems is physically replaced by a second robotic system, and digital twin operations are then transferred from the first robotic system to a second robotic system.

49. The method of claim 34, wherein the robotic system is configured to receive wireless power.
